(19) United States
(12) Patent Application Publication
(10) Pub. No.: US 2008/0203030 A1
(43) Pub. Date: Aug. 28, 2008

(54) Method of Extracting Organic Chemicals from Water or Air Using Polar Polyurethane as a Solid Extraction Medium

(75) Inventor: Timothy Thomson, West Newbury, MA (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: Hydrophilix Corporation, West Newbury, MA (US)

(21) Appl. No.: 10/588,365

(22) PCT Filed: Feb. 2, 2005
(86) PCT No.: PCT/US05/03389

§ 371 Date: Aug. 2, 2006

Related U.S. Application Data
(60) Provisional application No. 60/541,101, filed on Feb. 2, 2004.

(51) Int. Cl. B01J 49/00; B01D 15/04; B01D 53/22

(52) U.S. Cl. 210/670; 210/692; 95/45

(57) ABSTRACT

A method of extracting sparingly soluble organic contaminants from a water or gas stream is provided. Contaminants are removed from a contaminant stream by passing the stream through hydrophilic polyurethane or a composite comprising an open cell hydrophobic polyurethane foam having a plurality of surfaces defining a plurality of pores which have disposed thereon a coating of a substantially open cell hydrophilic polyurethane foam. The hydrophilic polyurethane or composite may then be regenerated when saturated with contaminant.

### BACKGROUND OF THE INVENTION

A natural and seemingly inevitable result of industrial development and human activity is the release of organic and inorganic contaminants to the environment. Industrial development has led to the release of contaminants that range in toxicity from benign to acute to chronic. Agricultural agents, especially those used in pesticides and herbicides, are or are associated with the formation of well-known pollutants.

Many of these contaminants are destroyed naturally in the biosphere. Naturally occurring clays and rocks are able to remove many pollutants from water by ion exchange and adsorption processes. Bacteria, molds, and algae all have the ability to metabolize pollutants. Septic tanks and municipal water waste treatment facilities depend on such bacteria to degrade human waste. When new pollutants are introduced into the environment, microorganisms, in most cases, evolve to use the contaminant as a food source.

The concentration of population in urban areas and large releases of industrial waste in many cases, however, have out-stripped the ability of the environment to handle the level of pollutants released. There are also classes of synthetic organic pollutants that have been designated recalcitrant in the sense that the natural environment does not seem capable of removing them. Halogenated hydrocarbons and certain pesticides are in this category.

These contaminants are found in water resources and in the air in populated areas. The concentration of polycyclic aromatic hydrocarbons (PAH), for example, was measured in the air around Chicago and Houston. The following chart shows the levels present.

| PAH | Chicago | Houston |
|---|---|---|
| Acenaphthalene | 76.9 | 22.8 |
| Fluorene | 74.8 | 24.2 |
| Phenanthrene | 200 | 50.1 |
| Anthracene | 14.1 | 1.4 |
| Fluoranthene | 44.1 | 10.2 |

The US Department of Agriculture monitors pesticide concentrations in ground water that result from agricultural run-off. Chlorine and phosphate-based chemicals are among the most toxic contaminants. An added complication is that these are non-point source releases i.e. there is not an identifiable release point that can be controlled.

Many of these organic, and in some cases inorganic, chemicals have a potential for bioaccumulation or, much worse, are acutely toxic to the populace. Despite this, there is still a lack of effective means for remediation of water and air containing these contaminants.

Among the processes used to treat water to remove contaminants are steam distillation, extraction, adsorption on activated charcoal, chemical oxidation and various biological and membrane techniques. In the latter category are treatment with microorganisms, reverse osmosis and treatment with enzymes.

Air can be injected into the soil around an aquifer and be recovered in sorption towers for concentration and removal of contaminants. Alternatively, subject to local regulation, water can be pumped from a contaminated aquifer through sorption columns and reinjected into the ground water system. In this context sorption means any process by which the fluid, air or water, is contacted with a material for which the pollutant has an affinity. The affinity can be physical trapping modified by some form of surface energy or can be a solvent extraction process. Fluid is pumped through the sorption medium and the amount of pollutant in the fluid is reduced.

The most common sorption medium is activated charcoal. Activated charcoal is charcoal that has been treated with oxygen to open up millions of tiny pores between the carbon atoms. These so-called active, or activated, charcoals are widely used to adsorb odorous or colored substances from gases or liquids.

When certain chemicals come in contact with a carbon surface, they attach to the surface and are trapped. Activated charcoal is good at trapping other carbon-based impurities (organic chemicals), as well as inorganics like chlorine. Many other chemicals are not attracted to carbon at all, e.g. sodium, nitrates, etc., and hence they pass through a bed of charcoal unaffected. Once all of the bonding sites of the charcoal are filled, however, an activated charcoal filter stops working.

Other extraction systems involve contacting contaminated air or water with a solvent for the pollutant. The solvent must be environmentally acceptable (e.g. biodegradable) or special precautions must be taken to ensure that the solvent is not released to the environment.

Biphasic extraction media, i.e. homopolymers and copolymers made from ethylene oxide and blends of ethylene oxide and propylene oxide, respectively, can be used as purification media. Because they are soluble in water themselves, they are not useful in a solvent extraction scheme. In order for them to be effective, once the extraction process has been performed, it is necessary to separate the pollutant from the medium. While biphasic extraction media can be used to extract contaminants from air, their water solubility precludes their use in purifying ground water. In the biphasic system, separation is achieved by the well-known physical chemical effect known as “salting out”. Inorganic salts are added to the system. This has the effect of “dehydrating” the polyol, thus making it insoluble and permitting separation.

One of the reasons such media are suitable for use in extraction processes, is that they are of variable molecular weight. At low molecular weight both polyethylene glycol and polypropylene glycol are water-soluble, but at higher molecular weights, polypropylene glycol is water insoluble. The extra methyl group prevents significant hydration. One of the most attractive features of this chemistry is that it is relatively benign, environmentally speaking. Separation of the phases are possible, but problematic, on a large scale.

Hydrophobic polyurethanes for use in water purification processes has been described by El Shahawi et al El-Shahawi, M. S., et al, Preconcentration and Separation of Some Organic Water Pollutants with Polyurethane Foam and Activated Carbon. 19. Int. Symp. on Chromatography, Aix-en-Provence (France) 13-18 Sep. 1992 CHROMATOGRAPHIA 1993 vol. 36, pp. 318-322. The author studied the use of polyurethane for the extraction of pesticides and similar compounds from water. He reported on an investigation of the extraction of Dursban, Karphos and Dyfonate by activated charcoal and a polyether polyurethane foam. El Shahawi, et al used hydrophobic (nonpolar) polyether polyurethanes in their work. They observed that as the polarity of the pesticide increases, the ability of polyurethane to extract it decreases.

### SUMMARY OF THE INVENTION

It has now been discovered that a hydrophilic, i.e., polar polyurethane can extract sparingly soluble organic chemicals from water and air. It has also been found that grafting the polyurethane onto a reticulated scaffold provides a high surface area composite with excellent flow-through properties.

When the terminal hydroxyl groups of the polyglycols are reacted with polyisocyanates and then the isocyanate-capped polyglycols are reacted with water a so-called hydrophilic polyurethane is produced having the extraction capability of the biphasic polyglycol, but in an insoluble form. This avoids the necessity of performing the problematic “salting out” process by which trapped impurities are removed and makes the system less temperature sensitive.

Preferably, the polyglycol is a homopolymer of ethylene glycol or a copolymer of polyethylene oxide and polypropylene oxide, the polypropylene oxide being no more than 90% of the total mass. The hydroxyl functionality of the polyols is preferably two or more. The isocyanate is preferably toluene diisocyanate, methylene bis diphenyl diisocyanate, isopherone diisocyanate or other commercially available polyisocyanates.

This polymer system is particularly effective at extracting sparingly soluble organic molecules from air and water. By adjusting the relative amounts of propylene oxide and ethylene oxide, one can affect the dipole moment of the system and thereby control the classes of compounds that are extractable. It has been found that grafting the copolymer onto an open cell foam, i.e., a scaffold, a flow-through, high surface area system is produced, making the extraction process more convenient.

The composites which can be used in the extraction methods of the present invention and methods for making these composites are described in U.S. Pat. No. 6,617,014 and in related U.S. Patent Publication No. US-2002-0018884-A1 and its PCT counterpart WO/01/7452A1. The details of same are known to the art and are specifically incorporated herein

Any sparingly soluble organic molecule can be extracted from an air or water stream by the methods of this application. Such molecules include saturated and unsaturated hydrocarbons which may be oxidized or substituted. The concentration of such molecules in air or water or in an industrial process stream is typically less than 1% by weight and more typically less than 0.1% of the weight of such stream.

The hydrophilic polyurethane can be regenerated once it becomes saturated by passing a heated gas, e.g., air through it to strip out the adsorbed contaminants.

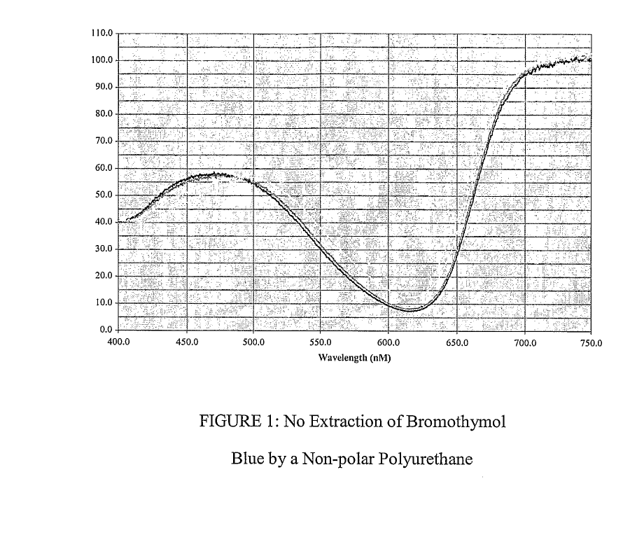

FIG. 1 shows the extraction of the polar dye, bromothymol blue, by a hydrophobic (nonpolar) polyether polyurethane.

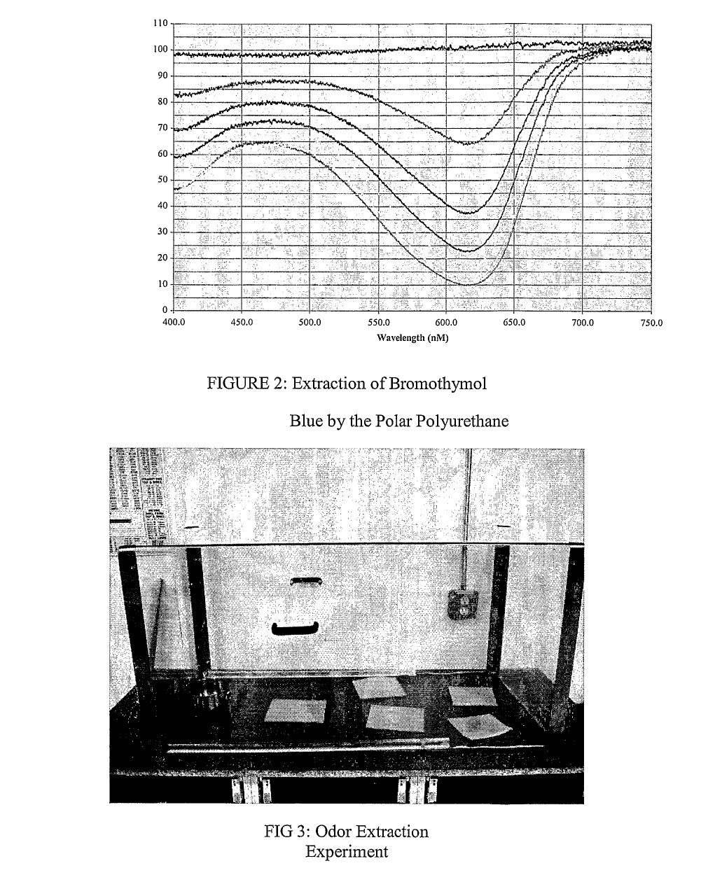

FIG. 2 shows the extraction of the dye by a polar polyurethane made by the reaction of polyethylene glycol, a polyisocyanate and water. The polyurethanes were immersed in a 0.05% bromothymol blue solution. Evidence of extraction is indicated by the decrease in the absorption of visible light.

The typical color response of bromothymol blue to changes in pH is maintained when it is extracted onto the subject polar polyurethane. When extracted onto hydrophobic polyurethane, it is no longer pH sensitive.

### EXAMPLE 1

A polar polyurethane, made as described above, was coated on the pores of a 30 pore per inch reticulated polyurethane foam as taught in Thomson, U.S. Pat. No. 6,617,014 and in related U.S. Patent Publication No. US-2002-0018884-A1 and its counterpart PCT Publication, WO/01/74582 A1. The foam was loaded into columns and a 100 ppm solution of methyl-tert-butylether (MtBE), a polar organic compound, was pumped through it. The construction details of the column and the throughput conditions are described below.

Length=280 cm

Inside Diam.=4.0 cm

Volume=3.5 liters

Foam Capacity=420 grams (typical)

Wt. Hydrophilic Foam=300 grams (typical)

Flow Rate=0.05 liters/min (typical)

Fixed Rate Peristaltic Pump

Temperature=15-45° C. (typical)

Control and Data Acquisition=Workbench on Macintosh Platform

Analytical=Gas Chromatograph and UV-VIS Spectrophotometry

Concentration=100 ppm MtBE

The MtBE solution was pumped through the columns and the effluent was analyzed to detect the first elution of MtBE. This first elution was termed the break-through and was used to calculate the “capacity” of the polymer. From these data it was determined that the column could extract about 3.5 mg MtBE per gram of polymer. The columns were then drained and purged with air heated to 65° C. overnight. MtBE solution was again pumped through the columns and the break-through again determined. It was found that after purging, the columns recovered the capacity to adsorb about 3.5 mg/gram. The ability to regenerate the column was thus confirmed.

### EXAMPLE 2

An air sample containing a fragrance was contacted with a piece of polar polyurethane and a piece of non-polar polyurethane, respectively. A sample of a commercial perfume was placed in a vessel in the chamber shown in FIG. 3. Pieces of hydrophobic polyurethane and of the polar polyurethane used in Example 1 were placed in the chamber for an hour. Regardless of the distance between the vessel containing the fragrance and the pieces of polyurethane, the polar polyurethane extracted the fragrance in the air, as evidenced by the smell of same, while the non-polar polyurethane did not.

### EXAMPLE 3

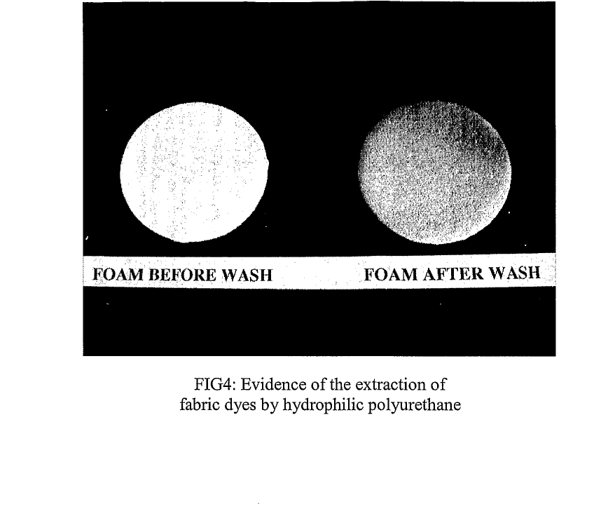

Hydrophilic polyurethane was used to extract fabric dyes from washing machine water. Six extra—large men's sweaters (three dark blue, one red and one green) were washed using the recommended procedures in a household washing machine using a commercial detergent. Several pieces of hydrophilic polyurethane foam were placed in the washer along with the sweaters. After a standard cycle the hydrophilic foam was removed and the color was examined. The results are shown in FIG. 4.

While the foregoing examples show the general characteristics of the invention, it will be apparent to those skilled in the art that other polar compounds can be extracted from air or water upon contact with polar polyurethane.

What is claimed is:

1. A method of extracting sparingly soluble organic contaminants from a water or gas stream comprising the steps of:
(a) passing said contaminant stream through hydrophilic polyurethane and thereby removing said contaminants; and
(b) regenerating said hydrophilic polyurethane when it becomes saturated with contaminant;

2. A method of extracting sparingly soluble aromatic components from an air stream comprising contacting said air stream with hydrophilic polyurethane.

3. A method of extracting fabric dye contained in clothes wash water comprising contacting said wash water with hydrophilic polyurethane.

4. A method of extracting sparingly soluble organic contaminates from a water or gas stream comprising the steps of:
(a) passing said contaminated stream through a composite comprising an open cell hydrophobic polyurethane foam, said hydrophobic foam having a plurality of surfaces defining a plurality of pores and having a coating of a substantially open cell hydrophilic polyurethane foam disposed upon said plurality of surfaces of the pores of said hydrophobic polyurethane foam and thereby removing said contaminants; and
(b) regenerating said composite when it becomes saturated with contaminants.

5. A method of extracting sparingly soluble aromatic components from an air stream comprising contacting said air stream with an open cell hydrophobic polyurethane foam, said hydrophobic polyurethane foam having a plurality of surfaces defining a plurality of pores and having a coating of a substantially open cell hydrophilic polyurethane foam disposed upon said plurality of surfaces of the pores of said hydrophobic polyurethane foam.

6. A method of extracting fabric dye contained in clothes wash water comprising contacting said wash water with an open cell hydrophobic polyurethane foam, said hydrophobic polyurethane foam having a plurality of surfaces defining a plurality of pores and having a coating of a substantially open cell hydrophilic polyurethane foam disposed upon said plurality of surfaces of the pores of said hydrophobic polyurethane foam.
